(19) United States
(12) Patent Application Publication
(10) Pub. No.: US 2012/0179288 A1
(43) Pub. Date: Jul. 12, 2012

(54) METHOD FOR CONTROLLING MULTIPLE SHOOTING POTS

(75) Inventors: Kevin Wing Hang Leung, Toronto (CA); Michael David Kershaw, Brampton (CA)

(73) Assignee: Husky Injection Molding Systems Ltd., Bolton, ON (CA)

(21) Appl. No.: 13/379,789

(22) PCT Filed: Jun. 21, 2010
(86) PCT No.: PCT/CA2010/000913

§ 371 Date: Jan. 24, 2012

Related U.S. Application Data
(60) Provisional application No. 61/230,242, filed on Jul. 31, 2009.

(51) Int. Cl. B29C 45/00

(52) U.S. Cl. 700/200

(57) ABSTRACT

A method (300) is provided for controlling an injection unit (100) having a first sub-assembly and a second sub-assembly, first and second sub-assemblies being functionally identical units. The method (300) includes the steps of appreciating an operational parameter for each of the first and second sub-assemblies, appreciating a target set point (146) associated with operating each of the first and second sub-assemblies, and when the operational parameter for at least one of the first and second sub-assemblies differs from the target set point (146), adjusting the operation of the at least one sub-assembly towards the target set point (146) by a control action. The adaptive control regulator (148) is operable to modify the control law of one of the first and second sub-assemblies so that the first and second sub-assemblies have substantially equal performance.

### TECHNICAL FIELD

The present invention generally relates to, but is not limited to molding of molded articles and more specifically, but not limited to, a method of matching the injection performance of multiple shooting pots.

### BACKGROUND

Molding is a process by virtue of which a molded article can be formed from molding material (such as Polyethylene Teraphalate (PET), Polypropylene (PP) and the like) by using a molding system. Molding process (such as injection molding process) is used to produce various molded articles. One example of a molded article that can be formed, for example, from PET material is a preform that is capable of being subsequently blown into a beverage container, such as, a bottle and the like.

A typical injection molding system includes inter alia an injection unit, a clamp assembly and a mold assembly. The injection unit can be of a reciprocating screw type or of a two-stage type. Within the reciprocating screw type injection unit, raw material (such as PET pellets and the like) is fed through a hopper, which in turn feeds an inlet end of a plasticizing screw. The plasticizing screw is encapsulated in a barrel, which is heated by barrel heaters. Helical (or other) flights of the screw convey the raw material along an operational axis of the screw. Typically, a root diameter of the screw is progressively increased along the operational axis of the screw in a direction away from the inlet end.

As the raw material is being conveyed along the screw, it is sheared between the flights of the screw, the screw root and the inner surface of the barrel. The raw material is also subjected to some heat emitted by the barrel heaters and conducted through the barrel. As the shear level increases in line with the increasing root diameter, the raw material, gradually, turns into substantially homogenous melt. When a desired amount of the melt is accumulated in a space at discharge end of the screw (which is an opposite extreme of the screw vis-à-vis the inlet end), the screw is then forced forward (in a direction away from the inlet end thereof), forcing the desired amount of the melt into one or more molding cavities. Accordingly, it can be said that the screw performs two functions in the reciprocating type injection unit, namely (i) plasticizing of the raw material into a substantially homogeneous melt and (ii) injecting the substantially homogeneous melt into one or more molding cavities.

The two stage injection unit can be said to be substantially similar to the reciprocating type injection unit, other than the plasticizing and injection functions are separated. More specifically, an extruder screw, located in an extruder barrel, performs the plasticizing functions. Once a desired amount of the melt is accumulated, it is transferred into a shooting pot, which is also sometimes referred in the industry as a “shooting pot”, the shooting pot being equipped with an injection plunger, which performs the injection function.

U.S. Pat. No. 6,241,932 issued to Choi et al. on Jun. 5, 2001 discloses a method and system of operating a two stage injection molding machine wherein movement of the injection plunger in the shooting pot is coordinated with movement of the plasticizing screw and melt flow into the shooting pot such that the plunger provides minimal resistance to the melt flow into the shooting pot while avoiding the production of voids or air inside the melt. The undesired shear forces to which the melt is exposed are thus reduced, correspondingly reducing the melt degradation products which would otherwise result.

U.S. Pat. No. 6,514,440 to Kazmer, et al. issued on Feb. 4, 2003 discloses an injection molding apparatus, system and method in which the rate of material flow during the injection cycle is controlled. According to one preferred embodiment, a method of open-mold purging is provided in an injection molding system including a manifold to receive material injected from an injection molding machine. The method includes the steps of selecting a target purge pressure; injecting material from the injection molding machine into the manifold; and controlling the purge pressure to substantially track the target purge pressure, wherein the purge pressure is controllable independently from the injection molding machine pressure.

U.S. Pat. No. 4,311,446 to Hold et al. issued on Jan. 19, 1982; U.S. Pat. No. 4,094,940 to Hold on Jun. 13, 1978; U.S. Pat. No. 3,937,776 to Hold et al. on Feb. 10, 1976; and U.S. Pat. No. 3,870,445 to Hold et al. on Mar. 11, 1975 each teaches a method and apparatus for controlling the parameters of injection molding processes in a machine having a barrel with a plasticizing chamber and a screw, rotatably and slidably disposed in said chamber, hopper means adjacent one end of said chamber communicating therewith and nozzle means disposed in the other end of said chamber communicating with a mold. Control of the injection molding process is achieved through an event recognition philosophy by sensing screw position, screw injection velocity, melt temperature, comparing the values at certain instances during the work cycle with known or desired values and using these values, changes of values and differences of values to monitor and initiate changes in the process parameters.

### SUMMARY

According to a first broad aspect of the present invention, there is provided a method of controlling an injection unit having a first sub-assembly and second sub-assembly by an adaptive control regulator. The method includes appreciating a respective operational parameter for each of the first sub-assembly and the second sub-assembly. The method further includes appreciating a target set point associated with operating each of the first sub-assembly and the second sub-assembly. When the respective operational parameter for at least one of the first sub-assembly and the second sub-assembly differs from the target set point, adjusting the respective performance of at least one of the first sub-assembly and the second sub-assembly towards the target set point by a control action. The adaptive control regulator is operable to modify the control action of one of the first sub-assembly and the second sub-assembly so that the first sub-assembly and the second sub-assembly have substantially equal performance.

According to a second broad aspect of the present invention, there is provided a controller for controlling an injection having a first sub-assembly and second sub-assembly and an adaptive control regulator. The controller is operable to appreciate a respective operational parameter for each of the first sub-assembly and the second sub-assembly. The controller is further operable to appreciate a target set point associated with operating each of the first sub-assembly and the second sub-assembly. When the respective operational parameter for at least one of the first sub-assembly and the second sub-assembly differs from the target set point, the controller is operable to adjust the respective performance of at least one of the first sub-assembly and the second sub-assembly towards the target set point by a control action. The adaptive control regulator is operable to modify the control action of one of the first sub-assembly and the second sub-assembly so that the first sub-assembly and the second sub-assembly have substantially equal performance.

### DESCRIPTION OF THE DRAWINGS

A better understanding of the embodiments of the present invention (including alternatives and/or variations thereof) may be obtained with reference to the detailed description of the embodiments along with the following drawings, in which:

FIG. 1 depicts a partially sectioned frontal view of an injection unit implemented according to a non-limited embodiment of the present invention.

FIG. 2 depicts a partially sectioned top view of the injection unit of FIG. 1.

FIG. 3 depicts a schematic for adaptive control being implemented on the injection unit of FIGS. 1 and 2.

FIG. 4 depicts a flow chart showing steps of a non-limiting embodiment of a method for controlling the injection unit of FIG. 1 and FIG. 2 using adaptive control.

FIG. 5 depicts a schematic of for adaptive control being implemented on a plurality of injection units.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

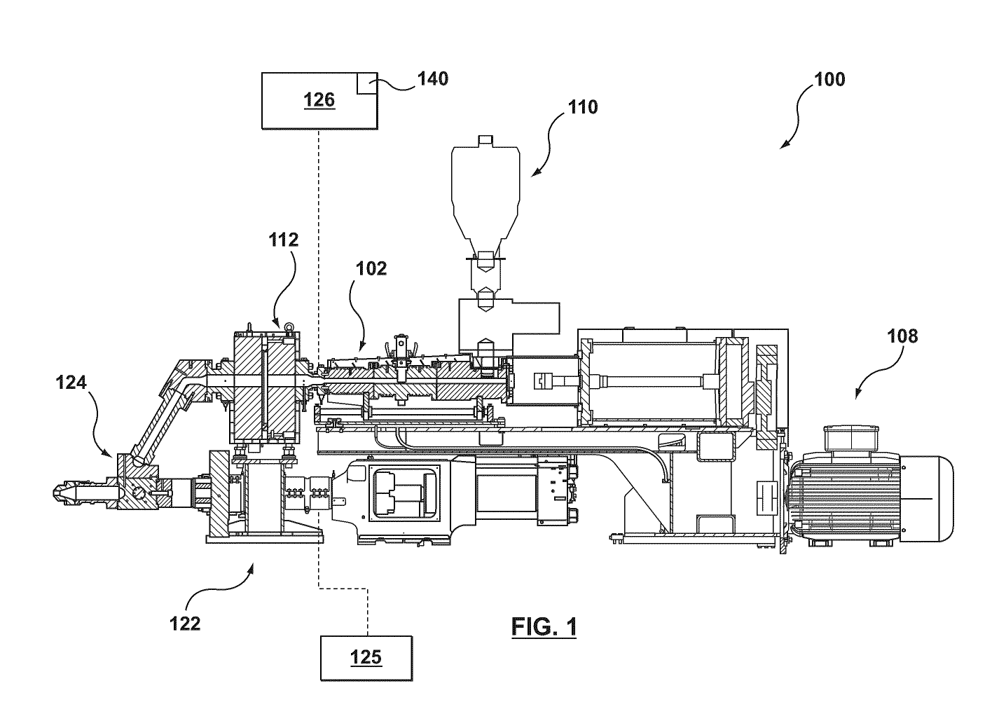

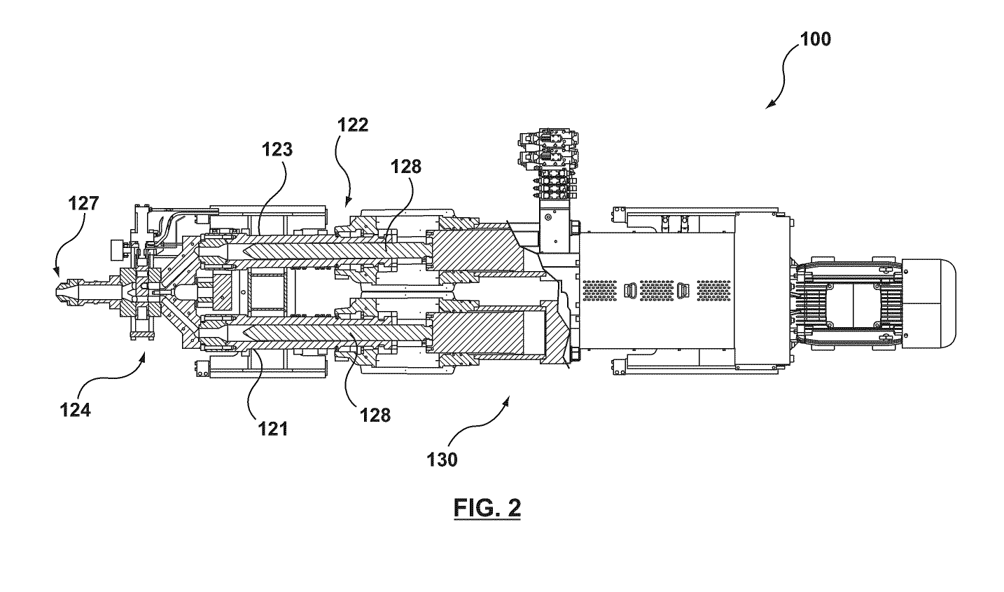

With reference to FIG. 1 and FIG. 2, an injection unit 100 implemented in accordance with non-limiting embodiments of the present invention, will now be described in greater detail, in which figures, FIG. 1 depicts a partially sectioned frontal view of the injection unit 100 and FIG. 2 depicts a partially sectioned top view of the injection unit 100.

Within the instantly illustrated embodiment, the injection unit 100 is of a two-stage type and to that extent, the injection unit 100 comprises a plurality of sub-assemblies, including an extruder 102 and a shooting pot 122. The extruder 102 houses a screw (not depicted) for plasticizing raw material, as will be described in greater detail herein below. In some embodiments of the present invention, the extruder 102 can be implemented as a twin screw extruder and, to that end, the extruder 102 can house a set of two screws (not depicted). The extruder 102 (or to be more precise, the screw within the extruder 102) is actuated by a screw actuator 108. In the specific non-limiting embodiment of the present invention, the screw actuator 108 comprises an electric motor coupled to the extruder 102 via a gear box (not separately numbered); however, this need not be so in every embodiment of the present invention. As such, it should be appreciated that the screw actuator 108 can be implemented differently, such as a hydraulic actuator, a mechanical actuator or a combination thereof. It should be noted that in alternative non-limiting embodiments, the injection unit 100 can be implemented as a single-stage injection unit with a reciprocating screw.

In some embodiments of the present invention, the extruder 102 can operate in a continuous plasticizing manner (i.e. extruder 102 can be implemented as a continuous extruder). In other embodiments, the extruder 102 can operate in a near continuous plasticizing manner. In yet further embodiments, the extruder 102 can operate in an interrupted plasticizing manner (especially so, when the extruder 102 is implemented as a reciprocating-type unit).

In the specific non-limiting embodiment depicted herein, the screw actuator 108 imparts a rotational movement onto the screw of the extruder 102 and it is this rotational movement that performs a dual function: (a) plasticizing of the raw material and (b) transfer of the raw material into the shooting pot 122,. As such, within this implementation, the screw of the extruder 102 is not associated with a reciprocal movement. In alternative embodiments, however, which are particularly applicable but not limited to scenarios where a single screw is employed in the extruder 102, the screw of the extruder 102 can be associated with the reciprocal movement, which can be imparted by the screw actuator 108 or by separate means (not depicted).

The injection unit 100 further includes a material feeder 110. The material feeder 110 is configured to supply raw material to the extruder 102. The material feeder 110 can be configured as a controlled (or metered) feeder or as a continuous feeder.

In a specific non-limiting embodiment of the present invention, the raw material is PET. In alternative embodiments, other materials or a mix of materials can be used. In a particular implementation of the embodiments of the present invention, the raw material includes a combination of virgin raw material and recycled raw material, in a particular proportion. The virgin raw material (which can come in a form of pellets, for example) and the recycled raw material (which can come in a form of flakes, for example) can be mixed at the material feeder 110 or at another upstream device (not depicted), such as a drier (not depicted), for example.

In addition to the material feeder 110, in some embodiments of the present invention, there may be provided an additive feeder (not depicted) for adding additional substances, such as for example colorants, acetaldehyde (AA) blockers and the like, to the extruder 102. Such additive feeders are well known in the art and, as such, will not be described here at any length.

There is also provided a filter 112, located fluidly in-between the extruder 102 and the shooting pot 122. The purpose of the filter 112 is to filter impurities and other foreign matters from the plasticized material being transferred from the extruder 102 to the shooting pot 122. It should be noted that in some embodiments of the present invention, which include but are not limited to scenarios where only virgin raw material is used, the filter 112 can be omitted.

Within the specific non-limiting embodiment being depicted herein, the shooting pot 122 is implemented as a dual shooting pot and to that extent the shooting pot 122 can include a first sub-assembly and a second sub-assembly, namely a first shooting pot 121 and a second shooting pot 123, selectively fluidly coupled to the extruder 102, as will be described in greater detail herein below. In alternative non-limiting embodiments of the present invention, the shooting pot 122 could include two or more injection units 100, each injection unit 100 having a single instance of the shooting pot 122 (not depicted).

Each of the first shooting pot 121 and the second shooting pot 123 includes an injection plunger 128 operatively disposed within the respective one of the first shooting pot 121 and the second shooting pot 123. The injection plunger 128 is actuated by a respective piston 130, which in this particular embodiment of the present invention is implemented as a hydraulic piston. However, in alternative non-limiting embodiments of the present invention, the injection plunger 128 can be actuated by a different type of an actuator (not depicted), such as mechanical actuator, electrical actuator and the like.

There is also provided a distribution assembly 124, located fluidly-in-between the extruder 102 and the shooting pot 122, downstream from the filter 112. The distribution assembly 124 is implemented as a distribution valve and is configured to selectively fluidly connect:

(a) the extruder 102 to the first shooting pot 121 while connecting the second shooting pot 123 to a nozzle 127, which provides for fluid communication with a molding cavity (not depicted) either directly or via a melt distribution system (not depicted), such as a hot runner (not depicted) for enabling for melt transfer from the extruder 102 to the first shooting pot 121 and melt injection from the second shooting pot 123 into the molding cavity (not depicted) via the nozzle 127;

(b) the extruder 102 to the second shooting pot 123 while connecting the first shooting pot 121 to the nozzle 127, for enabling for melt transfer from the extruder 102 to the second shooting pot 123 and melt injection from the first shooting pot 121 into the molding cavity (not depicted) via the nozzle 127.

There is also provided a condition sensor, schematically depicted in FIG. 1, at 125. Generally speaking, the condition sensor 125 is configured to sense one or more operational parameters associated with operation of the injection unit 100. In embodiments of the present invention, the condition sensor 125 can be implemented as one or multiple condition sensors of the same type or of different types, as will be described in greater detail herein below.

In some embodiments of the present invention, the condition sensor 125 can be implemented as a position sensor associated with respective each of the two instances of the shooting pot 122. Within this implementation the sensed condition comprises an indication of (a) a position and (b) speed associated with the respective one of the injection plunger 128 of the respective one of the first shooting pot 121 and the second shooting pot 123.

In other embodiments of the present invention, the condition sensor 125 can be implemented as a pressure sensor associated with each of the two instances of the shooting pot 122. Within this implementation the sensed condition comprises an indication of pressure of a compressible fluid associated with the respective one of the pistons 130. As such, the pressure of the compressible fluid can be that of oil used to actuate the respective one of the pistons 130 or the molding material being transferred into the respective one of the first shooting pot 121 and the second shooting pot 123. Naturally, other implementations for the condition sensor 125 are possible.

Also, provided within the architecture of FIG. 1 and FIG. 2 is a controller 126 (only depicted in FIG. 1 for the sake of simplicity). Controller 126 can be implemented as a general-purpose or purpose-specific computing apparatus that is configured to control one or more operations of the injection unit 100. It is also noted that the controller 126 can be a shared controller that controls operation of an injection molding machine (not depicted) that houses the injection unit 100 and/or other auxiliary equipment (not depicted) associated therewith Amongst numerous functions that can be controlled by the controller 126, some include (but are not limited to):

(i) Controlling the screw actuator 108 and more specifically the speed of rotation of the screw (not depicted) of the extruder 102;

(ii) Controlling the distribution assembly 124 for selectively implementing the melt transfer and melt injection switching between the two instances of the shooting pot 122, as has been discussed above;

(iii) Controlling the material feeder 110, where the material feeder 110 is implemented as controlled feeder, also referred to sometimes by those of skill in the art as a volumetric feeder;

(iv) Controlling the above-mentioned additive feeder (not depicted) in those embodiments where such additive feeder is provided;

(v) Receiving sensed one or more operational parameters from the condition sensor 125;

(vi) Controlling other auxiliary equipment (not depicted), such as a dryer and the like;

(vii) Performing a cycle optimization routine configured to analyze and optimize different parameters of the molding cycle.

The controller 126 can comprise internal memory 140 configured to store one or more instructions for executing one or more routines. These instructions and target set points 146 can be provided from an human machine interface, or HMI 142. The internal memory 140 can also store and/or update various parameters, such as but not limited to:

(i) Indication of a target set points 146 for the cycle time associated with the machine (not depicted) housing the injection unit 100;

(ii) Indication of the target set points 146 for speed and position, associated for example, with the injection plunger 128 for a given point in the molding cycle, generally referred to as a fill speed profile and a fill to hold transition position profile. (Alternately, fill to hold transition can be performed based on hydraulic pressure and fill time rather than based upon speed and position);

(iii) Indications of a hold pressure or hold position;

(iv) Indication of a target set point for the throughput for the transfer of molding material between the extruder 102 and the shooting pot 122.

(v) Set up parameters associated with the injection unit 100 or components thereof.

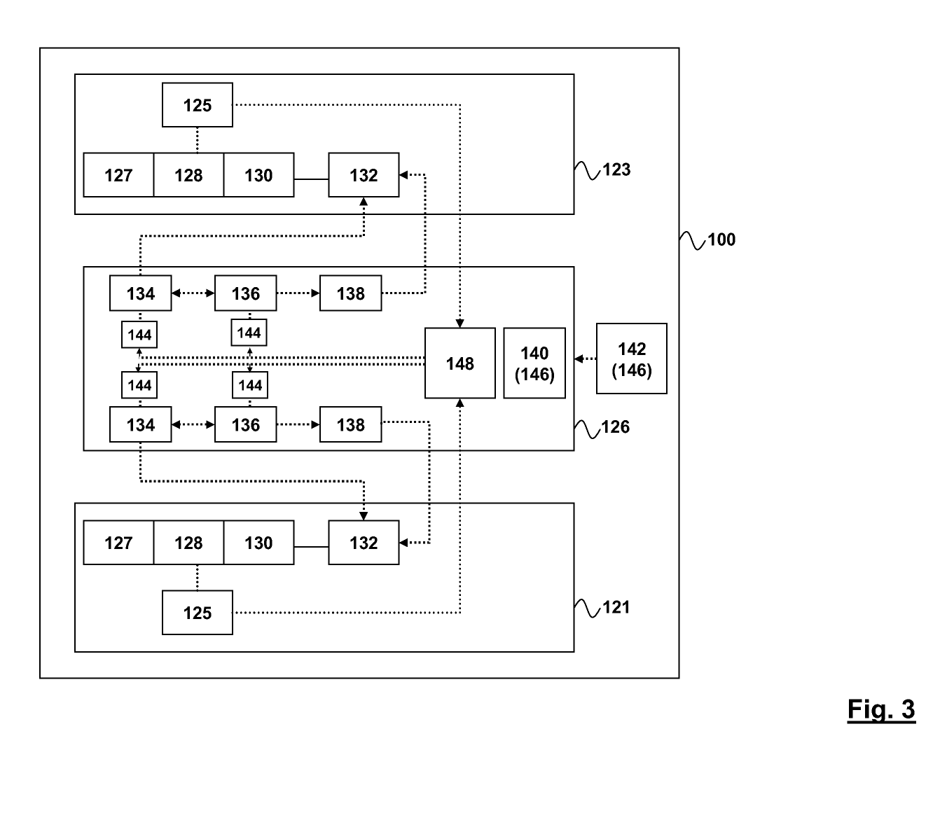

Given the architecture described with reference to FIG. 1 and FIG. 2, it is possible to execute a method for controlling multiple sub-assemblies on the injection unit using adaptive control over each sub-assembly. Referring now to FIG. 3, a schematic illustrating some of the operational parameters and target set points for each of the shooting pots 122 is shown in greater detail. As described previously, each shooting pot 122 (namely first shooting pot 121 and second shooting pot 123) includes an injection plunger 128 for expressing the melt out through nozzle 127. Each injection plunger 128 is coupled to a (hydraulically-motivated) piston 130. A hydraulic valve (or valves) 132 is (are) used to regulate both the speed of actuation and pressure of the pistons 130.

Through the regulation of hydraulic valve 132, controller 126 is operable to adjust the fill speed and hold pressure of each injection plunger 128 throughout each molding cycle to best approach one or more target set points 146. As discussed previously, condition sensor 125 can report the operational parameters of each injection plunger 128, such as position and speed, back to controller 126. Controller 126 can include sub-processes for different operating parameters, and in this case, includes a hold regulator 134, a fill regulator 136 and a linearization table 138 for each hydraulic valve 132. Each shooting pot 122 includes its own specific hold regulator 134, fill regulator 136 and linearization table 138. Hold regulator 134 and fill regulator 136 are operable to provide control law (generally closed loop control) for their respective shooting pot 122.

As known to those of skill in the art, the physical quality of a molded article is correlated to the fill and hold profiles of the injection operation throughout each molding cycle. These profiles are a product of applying the gain values 144 in hold regulator 134 and fill regulator 136, adjustments to linearization table 138 or other control actions. As the mechanical properties of the components in the shooting pots 122 change over time, so do the actual fill and hold profiles produced. As is known to those of skill in the art, applying the gain values 144 can be used for both open loop adjustments and closed loop adjustments using a PID controller, with or without feed forward correction.

The two shooting pots 122 are manufactured with tight tolerances to achieve almost identical characteristics. Therefore, the same gain values 144 and linearization table 138 could be applied to both shooting pots 122 to adjust their performance at the beginning of their service. However, the respective performance of each of these two shooting pots 122 will drift apart from each other over time, due to part wear, variations in thermal characteristics and/or accumulation of contaminants in components such as plungers, valves, and seals. Such a system would produce alternating levels of part quality between consecutive machine cycles, with application of the gain value achieving differing results. These manufacturing variations may not be acceptable to certain applications. In the case of dual shooting pots 122, one of the injection plungers 128 may be experiencing slightly higher friction than the other one during fill. The more “capable” injection plunger 128 must adapt (or slow down) in order to perform the same as the “sluggish” injection plunger 128 so that consistent parts can be produced in the mold.

Thus, each shooting pot 122 includes its own, independent linearization table 138, hold regulator 134 and fill regulator 136. Using desired fill and hold profiles and fill-to-hold transition (i.e. necessary to produce good and consistent part-to-part quality) as defined in target set points 146, gain values 144 and linearization tables 138 can be adjusted based on the actual profiles for each shooting pot 122 as measured by condition sensors 125. Controller 126 further includes an adaptive control regulator 148 which is used to modify the control law, thereby adjusting the rate of adjustment for each shooting pot 122. Adaptive control regulator 148 is described in greater detail below.

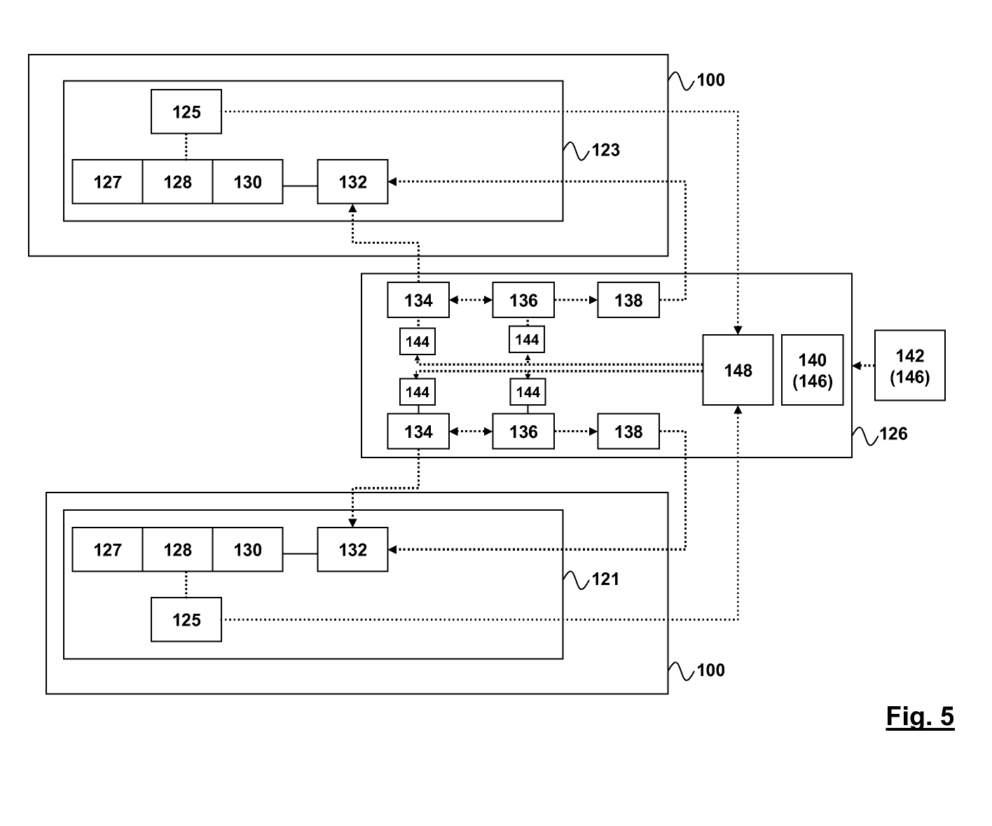

The approach can be applied to achieve identical performance in a fleet of injection units 100, each with a single shooting pot 122 (FIG. 5), or a fleet of injection units 100, each with dual shooting pots (not depicted). It does not have to be limited to shooting pots, but other functions such as part ejection and clamping (not depicted). Further, it is not limited to hydraulic functions, but electrically-actuated injection plungers 128 as well (also not depicted).

Adaptive control regulator 148 monitors the respective performance of individual control loops and adjusts the gain value, linearization tables or otherwise modifies the control law for each control loop such that a group of control loops can perform identically, despite process variations and changing component conditions over time.

### First Embodiments of A Method

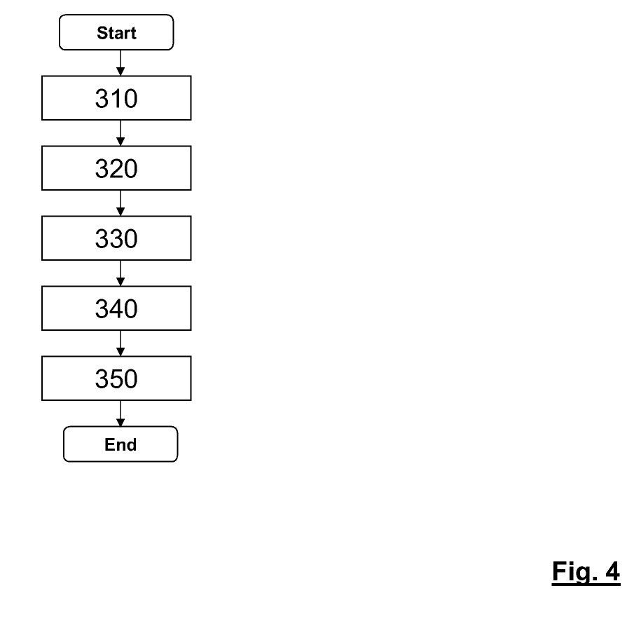

Referring now to FIG. 4, according to some embodiments of the present invention, the controller 126 can execute a method 300 for controlling a first sub-assembly and a second sub-assembly for a melt preparation device. Within these embodiments and for illustration purposes, it shall be assumed that:

(a) The extruder 102 is implemented as a continuous extruder;

(b) The material feeder 110 is implemented as a controlled feeder;

(c) The first sub-assembly is the first shooting pot 121 and the second sub-assembly is the second shooting pot 123, as is depicted in FIG. 2;

(d) The condition sensor 125 is implemented as a position sensor and a pressure sensor associated with each of the respective once of the first shooting pot 121 and the second shooting pot 123.

### Step 310

The method 300 begins at step 310, where the controller 126 appreciates a respective operational parameter associated with a shooting pot 122, namely the first shooting pot 121. In a particular example, the hold regulator 134 and fill regulator 136 receives, from the condition sensor 125, an indication of position, speed and back pressure of the injection plunger 128 associated with the first shooting pot 121.

### Step 320

The method 300 then proceeds to step 320, where the controller 126 appreciates a respective operational parameter associated with a shooting pot 122, namely, the second shooting pot 123. In a particular example, the hold regulator 134 and fill regulator 136 receives, from the condition sensor 125, an indication of position, speed and back pressure of the injection plunger 128 associated with the second shooting pot 123.

Although step 310 and 320 are depicted sequentially, it should be appreciated that the order of steps 310 and 320 could be reversed, or could occur simultaneously.

### Step 330

The method 300 then proceeds to step 330, where the controller 126 appreciates one or more target set points 146 associated with the operation of each of the first shooting pot 121 and the second shooting pot 123. In the presently-illustrated embodiment, the target set points 146 associated with each of the two shooting pots 122 are the same. In the presently-illustrated embodiment, the target set points 146 for the fill speed, fill to hold transition and hold pressure are stored within internal memory 140. In particular example, the controller 126 accesses the internal memory 140 and retrieves the target set points 146 for the hold pressure for each injection plunger 128.

In some embodiments of the present invention, the target set points 146 for hold pressure, fill speed, etc. can be stored in the internal memory 140 by an operator as part of a set-up process via an HMI 142. In alternative non-limiting embodiments of the present invention, the target set points 146 can include measured operational parameters associated with a previous molding cycle as sensed by the condition sensor 125 and stored in the internal memory 140. In yet further non-limiting embodiments of the present invention, the target set point 146 can be generated and stored by a cycle optimization routine executed by the controller 126, the cycle optimization routine configured to analyze and optimize different parameters of the molding cycle, including the required target hold pressure, fill speed, fill time, and/or fill to hold transition (whether the fill to hold transition is based upon position and time or pressure and time).

Although step 330 is depicted as occurring after steps 310/320, it should be appreciated that step 330 could occur before 310 or 320, or simultaneously therewith.

### Step 340

The method 300 then proceeds to step 340, at which point the controller 126, based on the operational parameter and the target set points 146, adjusts the performance of either or both of the shooting pots 122 from their measured operational value towards their target set points 146 by applying a control action using open or closed loop control law. Depending on the operational parameter which requires adjustment, controller 126 generates control actions according to the control law, such as applying the gain values 144 to hold regulator 134 or fill regulator 136 for either or both of the shooting pots 122. These control actions will change the fill speed, fill to hold transition or hold pressure for each shooting pot 122 to move towards the target set points 146.

### Step 350

The method 300 then proceeds to step 350, at which point the controller 126 determines whether or nor the respective performance of one of the two shooting pots 122 has drifted apart from the other shooting pot 122. If the control actions made by adaptive control regulator 148 are insufficient for both shooting pots 122 to achieve their target set points 146, then adaptive control regulator 148 will limit the respective performance of the higher performing shooting pot 122 to that of the lower performing shooting pot 122. Controller 126 adjusts the gain values 144, linearization tables 138 or otherwise so modifies the control law so that the control loops for each of the two shooting pots 122 achieves substantially similar levels of performance. For example, if the injection plunger 128 in the first shooting pot 121 was translating more slowly than the injection plunger 128 in the second shooting pot 123, and that adaptive control regulator 148 was unable to adjust the respective performance of the first shooting pot 121 sufficiently for it to meet its target set point 146, adaptive control regulator 148 could reduce the gain values 144 for fill regulator 136 so that the speed of injection plunger 128 in the second shooting pot 123 would more closely match the injection plunger 128 in the first shooting pot 121.

The description of the embodiments provides examples of the present invention, and these examples do not limit the scope of the present invention. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A method (300) of controlling an injection unit (100) having a first sub-assembly and second sub-assembly by an adaptive control regulator (148) operable to generate control actions as defined by a control law, comprising:
appreciating a respective operational parameter for each of the first sub-assembly and the second sub-assembly;
appreciating a target set point (146) associated with operating each of the first sub-assembly and the second sub-assembly;
responsive to the respective operational parameter for at least one of the first sub-assembly and the second sub-assembly differing from the target set point (146), applying a control action generated by the control law to adjust the respective performance of at least one of the first sub-assembly and the second sub-assembly towards the target set point (146); and
modifying the control law of one of the first sub-assembly and the second sub-assembly so that the first sub-assembly and the second sub-assembly subsequently generates different control actions in order to have substantially equal performance therebetween.

2. The method (300) of claim 1, wherein the first sub-assembly is a first shooting pot (121) and the second sub-assembly is a second shooting pot (123).

3. The method (300) of claim 2, wherein the target set point (146) is one of:
a fill speed for each of the first shooting pot (121) and the second shooting pot (123);
a fill to hold transition for each of the first shooting pot (121) and the second shooting pot (123); and
a hold pressure for each of the first shooting pot (121) and the second shooting pot (123).

4. The method (300) of claim 2, wherein appreciating the respective operational parameter comprises receiving an indication of the respective operational parameter from a condition sensor (125).

5. The method (300) of claim 4, wherein the condition sensor (125) comprises at least one of:
a position and speed sensor associated with an injection plunger (128) of at least one of the first shooting pot (121) and the second shooting pot (123); and
a pressure sensor associated with a piston (130) of the injection plunger (128).

6. The method (300) of claim 2, wherein the respective operational parameter comprises at least one of:
position associated with an injection plunger (128) of the at least one of the first shooting pot (121) and the second shooting pot (123);
speed associated with the injection plunger (128) of the at least one of the first shooting pot (121) and the second shooting pot (123); and
oil pressure associated with a piston (130) of the injection plunger (128); and
melt pressure associated with molding material being transferred into the at least one of the first shooting pot (121) and the second shooting pot (123); and
fill time associated with the injection plunger (128) of the at least one of the first shooting pot (121) and the second shooting pot (123).

7. The method (300) of claim 2, wherein the control action comprises applying tuning gains for a hold regulator (134) for at least one of the first shooting pot (121) and the second shooting pot (123).

8. The method (300) of claim 2, wherein the control action comprises applying tuning gains for a fill regulator (136) for at least one of the first shooting pot (121) and the second shooting pot (123).

9. The method (300) of claim 2, wherein the adaptive control regulator (148) is operable to modify the control action for at least one of:
(i) tuning gains for a hold regulator (134) for at least one of the first shooting pot (121) and the second shooting pot (123);
(ii) tuning gains for a fill regulator (136) for at least one of the first shooting pot (121) and the second shooting pot (123); and
(iii) linearization tables (138) for at least one of the first shooting pot (121) and the second shooting pot (123).

10. A controller (126) for controlling an injection unit (100) having a first sub-assembly and second sub-assembly and an adaptive control regulator (148) providing control law for the injection unit (100), the controller (126) being operable:
to appreciate a respective operational parameter for each of the first sub-assembly and the second sub-assembly;
to appreciate a target set point (146) associated with operating each of the first sub-assembly and the second sub-assembly;
where the respective operational parameter for at least one of the first sub-assembly and the second sub-assembly differs from the target set point (146), to apply a control action to adjust the respective performance of at least one of the first sub-assembly and the second sub-assembly towards the target set point (146) according to the control law; and
wherein the adaptive control regulator (148) is operable to modify the control law of one of the first sub-assembly and the second sub-assembly so that the first sub-assembly and the second sub-assembly can then subsequently generate different control actions in order to have substantially equal performance therebetween.

11. The controller (126) of claim 10, wherein the first sub-assembly is a first shooting pot (121) and the second sub-assembly is a second shooting pot (123).

12. The method (300) of claim 11, wherein appreciating the respective operational parameter comprises receiving an indication of the respective operational parameter from a condition sensor (125).

13. The controller (126) of claim 11, wherein the respective operational parameter comprises at least one of:
position associated with an injection plunger (128) of the at least one of the first shooting pot (121) and the second shooting pot (123);
fill time associated with at least one of the first shooting pot (121) and the second shooting pot (123);
speed associated with the injection plunger (128) of the at least one of the first shooting pot (121) and the second shooting pot (123); and
oil pressure associated with a piston (130) of the injection plunger (128); and
melt pressure associated with molding material being transferred into the at least one of the first shooting pot (121) and the second shooting pot (123).

14. The controller (126) of claim 11, wherein the control action comprises applying tuning gains for a hold regulator (134) for at least one of the first shooting pot (121) and the second shooting pot (123).

15. The controller (126) of claim 12, wherein the adaptive control regulator (148) is adapted to modify the control action for at least one of:
tuning gains for a hold regulator (134) for at least one of the first shooting pot (121) and the second shooting pot (123);
tuning gains for a fill regulator (136) for at least one of the first shooting pot (121) and the second shooting pot (123); and
linearization tables (138) for at least one of the first shooting pot (121) and the second shooting pot (123).
